(19) United States
(12) Patent Application Publication
(10) Pub. No.: US 2024/0209667 A1
(43) Pub. Date: Jun. 27, 2024

(54) SWINGING-SLIDING DOOR, VEHICLE HAVING A SWINGING-SLIDING DOOR AND METHOD FOR OPERATING THE SWINGING-SLIDING DOOR

(71) Applicants: BODE - DIE TÜR GMBH, Kassel (DE); BROSE FAHRZEUGTEILE GMBH & CO. KOMMANDITGESELLSCHAFT, BAMBERG, Bamberg (DE)

(72) Inventors: Markus KOTHE, Velbert (DE); Philipp BÄUERLEIN, Heiligenstadt (DE); Christian GITTER, Zeil (DE); Jörg STÜBINGER, Mainleus (DE); Markus ROSENTHAL, Bamberg (DE); Andreas PELLEGRINI, Edermünde (DE)

(21) Appl. No.: 18/577,582

(22) PCT Filed: Jul. 5, 2022
(86) PCT No.: PCT/EP2022/068573

§ 371 Date: Jan. 8, 2024

(30) Foreign Application Priority Data
Jul. 8, 2021 (DE) 10 2021 117 684.0

(51) Int. Cl. E05D 15/10

(52) U.S. Cl. CPC E05D 15/1068; E05D 2015/1071; E05Y 2600/13

(57) ABSTRACT

A swinging-sliding door for a vehicle, particularly for a public transport vehicle, with fastening components for fastening the swinging-sliding door on the vehicle and
a door leaf that can be displaced between a closed position and an open position via intermediate positions, and
with a door leaf displacement device for displacing the door leaf, wherein the door leaf displacement device has a controllable actuator, as well as a guide element that can be adjusted by the controllable actuator, and wherein the open position and/or the intermediate positions of the door leaf can be changed by adjusting the adjustable guide element.

### CROSS-REFERENCE TO RELATED APPLICATIONS

This application is a 35 U.S.C. § 371 National Stage patent application of PCT/EP2022/068573, filed on 5 Jul. 2022, which claims the benefit of German patent application 10 2021 117 684.0, filed on 8 Jul. 2021, the disclosures of which are incorporated herein by reference in their entirety.

### TECHNICAL FIELD

The disclosure pertains to a swinging-sliding door for a vehicle, particularly for a public transport vehicle, with fastening means for fastening the swinging-sliding door on the vehicle and a door leaf that can be displaced between a closed position and an open position via intermediate positions, and with a door leaf displacement device for displacing the door leaf.

The disclosure also pertains to a vehicle with such a swinging-sliding door and to a method for operating such a swinging-sliding door or such a vehicle.

### BACKGROUND

A swinging-sliding door of this type is already known from EP 1 527 975 A1. In swinging-sliding doors for public transport vehicles, particularly swinging-sliding doors for local public transport vehicles such as buses or automatically operating transport means for short distances, e.g. at airports or fairs, it can be advantageous to tilt the door leaf in a defined manner in a certain region in order to prevent collisions, for example, with a turned wheel or mirrors of the vehicle. In known swinging-sliding doors, this is frequently realized in that the door leaf is always tilted and also always tilted by the same distance regardless of whether or not this is required by the vehicle, e.g. because a wheel is currently turned. The disadvantage of this can be seen in that the tilting process can be associated with negative side effects such as collisions of the door leaf with passengers or an excessive space requirement.

### SUMMARY

The disclosure therefore is based on making available a swinging-sliding door, a vehicle with such a swinging-sliding door and a method for operating such a swinging-sliding door or such a vehicle, which are improved at least with respect to one of the aforementioned disadvantages.

This is attained by providing the swinging-sliding door specified in the claim 1, the vehicle specified in claim 9 and the method specified in claim 10.

In the disclosed swinging-sliding door, the door leaf displacement device has a controllable actuator, as well as a guide element that can be adjusted by the controllable actuator. The open position and/or the intermediate positions of the door leaf can be changed by adjusting the adjustable guide element by means of the controllable actuator.

In this way, the door leaf can be displaced parallel to the vehicle, whenever and as long as this is possible, in order to prevent collisions of the door leaf, e.g., with passengers and to preserve a space-saving design. Since the open position and/or the intermediate positions of the door leaf can be changed, however, a tilting process can take place when this is currently required by the vehicle, e.g. due to a turned steering mechanism. In this way, potential negative side effects associated with a tilting process can be reduced to a minimum. In addition, the same swinging-sliding door can be used for different vehicles in such a way that a required tilting process is only carried out to the smallest degree necessary. For example, it is not absolutely necessary to construct two different swinging-sliding doors for two vehicles with different distances between the steerable wheel and the swinging-sliding door in order to reduce the tilting process to the unavoidable minimum degree. The manufacturing expenditure for the swinging-sliding door can thereby be reduced.

The dislocation of the door leaf between the closed position and the open position preferably comprises a component of a translatory displacement of the door leaf, as well as a component of a rotatory motion of the door leaf about a rotational axis. The rotatory motion preferably can be changed by adjusting the guide element by means of the controllable actuator.

The dislocation of the door leaf between the closed position and the open position may comprise just one rotatory motion of the door leaf. Alternatively, the dislocation of the door leaf between the closed position and the open position may comprise multiple rotatory motions of the door leaf, which take place at different locations of the translatory motion.

The at least one rotatory motion preferably takes place during the displacement of the door leaf. The controllable actuator may be able to change the size of the rotational angle of the rotatory motion. The controllable actuator may be able to change the location of the translatory displacement, at which the rotatory motion takes place.

In one embodiment, the component of the translatory displacement of the motion of the door leaf between the closed position and the open position cannot be changed. It was determined that it is possible to forgo such a change and that the construction of the swinging-sliding door is thereby simplified.

The intermediate positions preferably are not arbitrary, but rather predefined or predefinable. The translatory displacement preferably takes place along a curved motion path.

The controllable actuator preferably is operatively connected to a control. In the context of this publication, the term “control” refers to an electronic control. It is basically conceivable that the controllable actuator is operatively connected to a superordinated control, e.g. of the vehicle. However, the swinging-sliding door preferably has its own control. In this way, the effort for adapting the swinging-sliding door to the vehicle can be reduced.

The swinging-sliding door preferably comprises a control with an input and an output. Furthermore, the control preferably is designed for receiving—preferably changing—steering angle deflection signals of a wheel of the vehicle via its input. The output of the control preferably is operatively connected to the controllable actuator. The control may also be designed for receiving unchanging signals such as vehicle contour signals, which may be dependent, e.g., on the position and size of an exterior rearview mirror of the vehicle, via its input.

The control preferably is designed for outputting signals via its output in dependence on the input signals. For example, it may output a control signal when the input signal indicates that a predefined steering angle has been exceeded.

The actuator preferably comprises an input that is designed for receiving control signals, which are dependent on changing vehicle circumstances such as steering angle deflections of a wheel of the vehicle and/or on unchanging vehicle circumstances such as the position of a mirror of the vehicle.

In the preferred embodiment, the door leaf displacement device comprises a door leaf guide for guiding the door leaf between the closed position and the open position via intermediate positions. It is furthermore preferred that the door leaf displacement device comprises a door leaf drive.

The door leaf guide preferably comprises a translational guide. The translational guide preferably guides the translatory displacement of the door leaf. The translational guide preferably has a carrier with a longitudinal extent extending in the longitudinal direction, wherein said carrier has a linear longitudinal guide, by means of which the door leaf is mounted on the carrier so as to be displaceable in the longitudinal direction. In addition, the translational guide preferably comprises a linear transverse guide, by means of which the carrier is mounted so as to be displaceable relative to the fastening means in the transverse direction. A robust translational guide can thereby be realized. The fastening means preferably are designed stationary in relation to the vehicle. The translational guide preferably comprises a translational guide arm, which is connected to the linear longitudinal guide and on which a translational guide roller preferably is arranged. In addition, the translational guide preferably comprises a translational guide track that is arranged stationary in relation to the fastening means, wherein the translational guide roller can be arranged in this translational guide track. The linear transverse guide preferably comprises two guide parts, which preferably are respectively arranged on the carrier on the ends thereof. The longitudinal direction and the transverse direction preferably extend at least approximately horizontally in the installed position of the swinging-sliding door. The translational guide roller arranged in the translational guide track preferably couples a displacement of the longitudinal guide relative to the carrier with a displacement of the carrier in the transverse direction such that a coordinated translatory motion of the door leaf in the longitudinal and the transverse direction, which is predefined by the extent of the translational guide track, takes place during a displacement of the longitudinal guide relative to the carrier. The linear longitudinal guide and/or the linear transverse guide may comprise a roller guide. The translational guide arm may be arranged directly or indirectly on the linear longitudinal guide. The translational guide track preferably lies in the plane defined by the longitudinal and the transverse direction or in a plane extending parallel thereto. The translational guide track preferably has straight and curved sections. The translational guide track preferably has sections that extend parallel to the longitudinal direction.

The door leaf guide preferably comprises a rotational guide. The rotational guide preferably guides the rotatory motion of the door leaf. The rotational guide preferably comprises a rotational guide arm, which is connected to the door leaf and on which a rotational guide roller preferably is arranged. Furthermore, the rotational guide preferably comprises a rotational guide track that preferably is arranged stationary in relation to the fastening means, wherein the rotational guide roller preferably is arranged in this rotational guide track. The extent of the rotational guide track preferably can be changed by means of the controllable actuator. In addition, the rotational guide preferably comprises a pivot joint, by means of which the door leaf is connected to the linear longitudinal guide.

The translational guide track and the rotational guide track preferably have identical regions. In the context of this publication, this refers to regions that can be projected on one another, preferably as a result of a translatory displacement. It is preferred that no rotation of the door leaf takes place when the translational guide roller and the rotational guide roller roll in identical regions of the translational guide track and the rotational guide track. A rotation of the door leaf preferably takes place when the translational guide roller and the rotational guide roller roll in non-identical regions of the translational guide track and the rotational guide track. The rotational guide track preferably has a non-adjustable section and an adjustment section. The adjustable guide element preferably is part of the rotational guide and preferably also forms the adjustment section of the rotational guide track. It is preferred that the adjustment section is arranged directly adjacent to the non-adjustable section of the rotational guide track. The adjustment section may have an unchangeable curvature. It preferably is straight. Once the rotational guide roller reaches the adjustable guide element, it follows the adjustment section and the door leaf is adjusted accordingly. If the adjustment section forms a guide track region that is identical to the region of the translational guide track, in which the translational guide roller is arranged at this point in time, the translatory displacement of the door leaf preferably is continued and no rotation of the door leaf preferably takes place in this case. However, if the adjustment section forms a guide track region that is not identical to the region of the translational guide track, in which the translational guide roller is arranged at this point in time, the translatory displacement of the door leaf preferably is not continued, but a rotatory motion rather is preferably superimposed upon the translatory displacement of the door leaf. The resulting motion travel of the door leaf or the displacement of the door leaf between the closed position and the open position via the intermediate positions depends on the shape and/or length and/or rotational position of the adjustable guide element. The translational guide track and the rotational guide track may exclusively have identical regions with the exception of the adjustment section. The rotational guide track may in its non-adjustable section have a region that is not identical to the translational guide track in order to achieve so-called “undercut travel.”

The adjustable guide element preferably is mounted so as to be rotatable about an adjustment axis. The adjustment axis preferably extends parallel to the joint axis. The adjustable guide element may be U-shaped and the adjustment axis may be arranged in one leg of this U-shape. The other leg may have a slot guide with a curved slot that guides a rotation of this leg about the adjustment axis.

The joint axis of the pivot joint preferably extends parallel to the door leaf plane. The pivot joint preferably defines the rotational axis of the door leaf. The rotational axis of the rotatory motion of the door leaf preferably coincides with the joint axis of the pivot joint.

The translational guide track and the rotational guide track preferably are produced in a guide plate. The translational guide track and the rotational guide track may be produced in the same guide plate. The adjustable guide element may be rotatably mounted on the guide plate.

A tensile or compressive force originating from the rotational guide roller preferably acts upon the door leaf when the translational guide roller and the rotational guide roller roll in non-identical regions of the translational guide track and the rotational guide track. The rotational guide arm preferably is designed in such a way that this tensile or compressive force is introduced into the door leaf or into a rigid element permanently connected to the door leaf, e.g. a lever section of the rotational guide arm, on a region that does not lie on a line with the imaginary connection between the rotational guide roller and the joint axis, but rather is spaced apart from this line by a distance. The lever section may be designed perpendicular to the remaining rotational guide arm. The lever section may extend at least approximately parallel to the door leaf plane. It may protrude from the door leaf on its side facing the pivot joint. The distance preferably forms the effective lever arm for the rotation of the door leaf.

It is preferred that the translational guide roller and the rotational guide roller respectively are rotatably mounted on the associated guide arm in a pivot bearing.

The translational guide track and the rotational guide track preferably are, with the exception of a so-called undercut travel, designed identical over the greatest length possible because collisions with passengers can be prevented and a space-saving operation of the swinging-sliding door can be achieved in that the door leaf is displaced parallel to the vehicle as long as possible.

The region of the rotational guide track, which cannot be changed by the controllable actuator, may be entirely or partially designed identical to the translational guide track. Due to the regions of the [text missing] of the door leaf, which cannot be changed by the controllable actuator and do not extend identical to the translational guide track, an identical rotation of the door leaf can take place during any movement of the door leaf between the open position and the closed position, e.g. a so-called undercut travel, in which a rotation takes place shortly before reaching the closed position and shortly after leaving the closed position.

The guide tracks preferably have guide walls that are respectively spaced apart from one another and therefore can also be referred to as guide slots. The translational guide track with its translational guide roller, as well as the rotational guide track with its rotational guide roller, can be referred to as a slotted guide. The guide of each door leaf therefore preferably comprises a double slotted guide, wherein it is furthermore preferred that just one slot can be changed.

The translational guide arm preferably produces a rigid connection between the pivot bearing of the translational guide roller and the linear longitudinal guide. The rotational guide arm preferably produces a rigid connection between the pivot bearing of the rotational guide roller and the door leaf.

The rotational guide preferably is at least partially displaced along by the translational guide. The rotational guide preferably is completely displaced along by the translational guide with the exception of the rotational guide track.

In the preferred embodiment, the door leaf displacement device comprises just one door leaf drive. In comparison with a conceivable swinging-sliding door with multiple door leaf drives, e.g. one door leaf drive for the component of the translatory displacement of the door leaf and another door leaf drive for the component of the rotatory motion of the door leaf about a rotational axis, this makes it possible to achieve a simple and robust construction, which furthermore may require less structural space.

The door leaf drive preferably comprises a driving motor, preferably just one driving motor. The driving motor may comprise a rotary motor or a linear motor. The driving motor may comprise an electric motor or, for example, a pneumatic or hydraulic motor. The driving motor preferably comprises an electric rotary motor such as a stepping motor. The driving motor preferably is fastened on the carrier stationary thereto. The driving motor preferably causes a displacement of the linear longitudinal guide relative to the carrier in the longitudinal direction. In this case, the translational guide roller moves along the translational guide track such that a coordinated translatory motion of the door leaf takes place in the longitudinal and the transverse direction. The power transmission between the door leaf drive and the linear longitudinal guide may be realized by means of a spindle. It may also be realized by means of a belt, e.g. a toothed belt or cam belt, which revolves between a belt pulley arranged on the driving motor shaft and a belt deflection pulley arranged on the carrier and is fastened on the linear longitudinal guide. It is also conceivable to use a cable instead of a belt. The driving motor preferably has a housing that preferably is fastened on the carrier in a stationary manner. The door leaf drive preferably does not use a reactive force of the driving motor, e.g. a reactive force originating from the housing of the driving motor. The construction can thereby be simplified.

The controllable actuator preferably differs from the door leaf drive. The actuator preferably does not serve for driving the door leaf. The controllable actuator preferably comprises a servomotor. The servomotor may comprise a rotary motor or a linear motor. The servomotor may comprise an electric motor or, for example, a pneumatic or hydraulic motor. The servomotor preferably comprises an electric rotary motor such as a stepping motor. The power transmission between the controllable actuator and the adjustable guide element may be realized, for example, by means of a spindle drive. The servomotor preferably has a housing that preferably is fastened stationary in relation to the fastening means, for example on the guide plate.

The swinging-sliding door may comprise two door leaves. The dislocations of these two door leaves between the closed position and the open position can deviate from one another. The dislocations of the two door leaves preferably deviate from one another in such a way that the amount, by which the rotational position of the door leaf in the open position respectively deviates from the rotational position of the same door leaf in the closed position, differs regardless of the rotational direction of the deviation.

The swinging-sliding door of the disclosed vehicle or the remaining disclosed vehicle comprises a control with a control input and a control output. A steering angle sensor preferably is provided for detecting the steering angle of the vehicle and the control input is operatively connected to the steering angle sensor. The angle value of the steering angle deflection therefore is preferably transmitted to the control. The control output preferably is operatively connected to the controllable actuator.

The disclosed method for operating the swinging-sliding door comprises the following steps:

Determining the steering angle of the vehicle and changing the open position and/or the intermediate positions of the door leaf in dependence on the determined steering angle.

The steering angle preferably is determined by means of a steering angle sensor. The motion path of the door leaf preferably is changed in dependence on the determined steering angle in such a way that the door leaf extends parallel to the vehicle as long as possible without colliding with the turned wheel of the vehicle.

It is preferred to define a steering angle, beyond which the door leaf collides with the wheel during a purely translatory displacement.

The actuator preferably is activated once the steering angle exceeds the defined value.

The control preferably outputs signals via its output in dependence on the input signals. For example, it can output a control signal when the input signal indicates that a predefined steering angle is exceeded.

In the method for operating a swinging-sliding door having two door leaves, the change of the open position and/or the intermediate positions of the door leaf in dependence on the determined steering angle may only take place on just one door leaf.

The characteristics of the swinging-sliding door, the vehicle with the swinging-sliding door and the method for operating the swinging-sliding door can be combined with one another.

### BRIEF DESCRIPTION OF THE DRAWINGS

The disclosure is described in greater detail below with reference to an exemplary embodiment illustrated in the drawings. In these schematic drawings:

FIG. 1 shows a top view of an exemplary embodiment of a disclosed swinging-sliding door with door leaves in the closed position;

FIG. 2 shows the swinging-sliding door according to FIG. 1 with the door leaves in an intermediate position;

FIG. 3 shows the swinging-sliding door according to FIG. 1 with the door leaves in a parallel open position;

FIG. 4 shows the swinging-sliding door according to FIG. 1 with the door leaves in an oblique open position;

FIG. 5 shows a perspective view of the swinging-sliding door according to FIG. 4;

FIG. 6 shows a schematic diagram of a swinging-sliding door according to FIG. 2, in which only one door leaf is illustrated;

FIG. 7 shows a schematic diagram of a swinging-sliding door according to FIG. 3, in which only one door leaf is illustrated;

FIG. 8 shows a top view of multiple positions of the door leaf during parallel opening; and

FIG. 9 shows a top view of multiple positions of the door leaf during oblique opening.

### DETAILED DESCRIPTION OF THE DRAWINGS

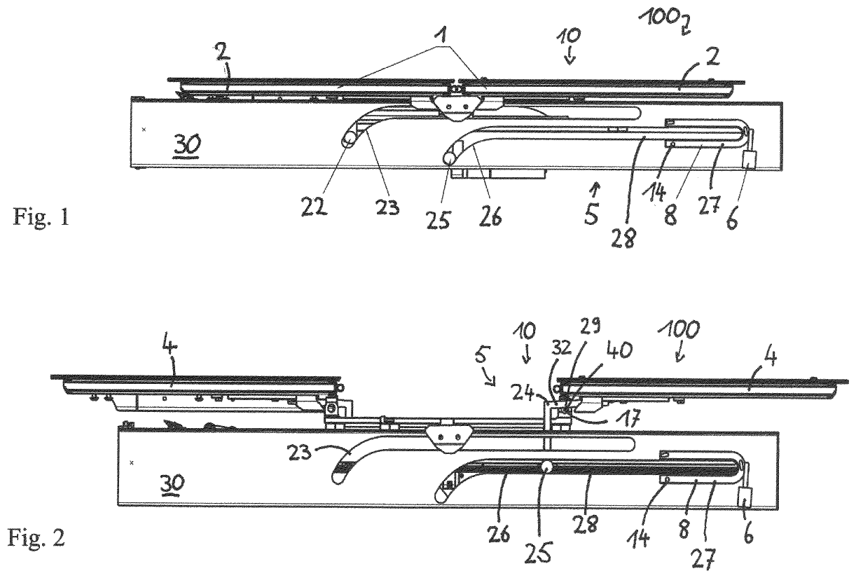

FIG. 1 shows an exemplary embodiment of the swinging-sliding door for a public transport vehicle, wherein said swinging-sliding door is identified as a whole by the reference symbols 100. The exemplary embodiment shown has two door leaves 1. A synopsis of FIGS. 1 to 4 shows that both door leaves 1 can be respectively displaced between a closed position 2 and an open position 3 via intermediate positions 4. FIGS. 1 to 3 show the opening of the swinging-sliding door 100, for example, when the steering mechanism of the vehicle is not turned. FIGS. 1, 2 and 4 show the opening of the swinging-sliding door 100, for example, when the steering mechanism of the vehicle is turned.

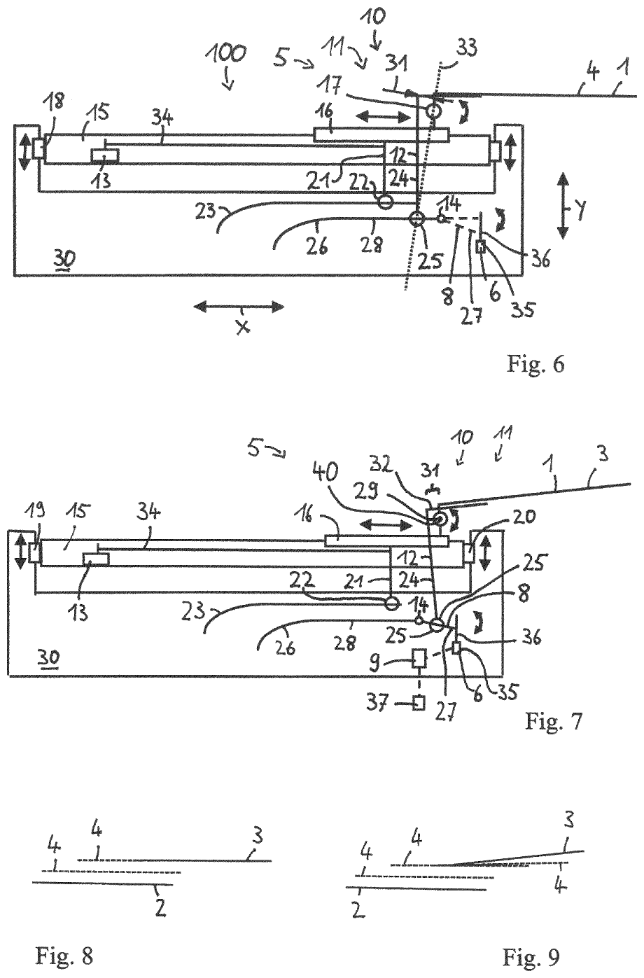

A door leaf displacement device 5 (FIGS. 6 and 7) is provided for displacing each door leaf 1. Only the door leaf 1 illustrated on the right side in FIG. 1 initially is described in greater detail below.

The door leaf displacement device 5 has a controllable actuator 6, as well as a guide element 8 that can be adjusted by the controllable actuator 6. The open position 3 and the intermediate positions 4 of the door leaf 1 can be changed by adjusting the guide element 8 by means of the controllable actuator 6.

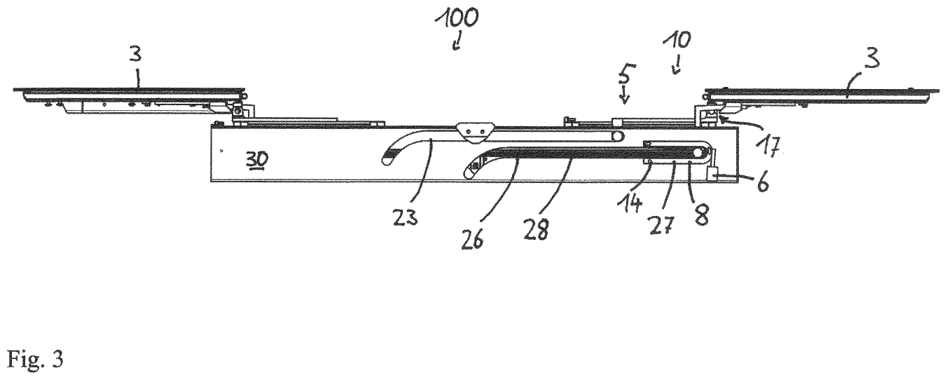

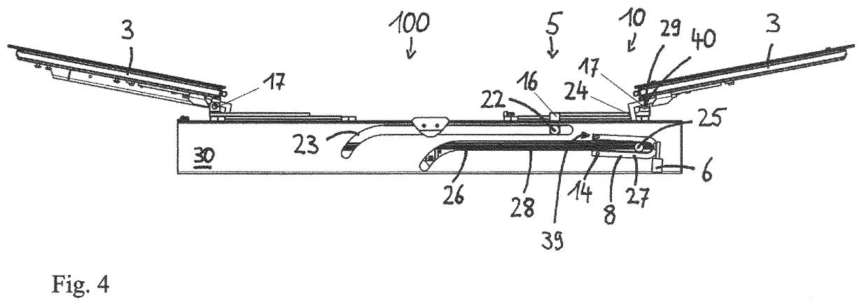

A comparison between FIGS. 3 and 4 shows that the displacement of the door leaf 1 between the closed position 2 and the open position 3 may exclusively comprise a component of a translatory displacement of the door leaf 1 (FIG. 3), as well as an additional component of a rotatory motion of the door leaf 1 about a rotational axis 40 (FIG. 4). The rotatory motion can be changed by adjusting the guide element 8 by means of the controllable actuator 6 whereas the component of the translatory displacement of the motion of the door leaf 1 between the closed position 2 and the open position 3 cannot be changed. The translatory displacement takes place along a curved motion path.

The swinging-sliding door 100 has its own control 9 (which is only illustrated in FIG. 7), wherein said control receives steering angle signals of the vehicle via its input and its output is connected to the actuator 6.

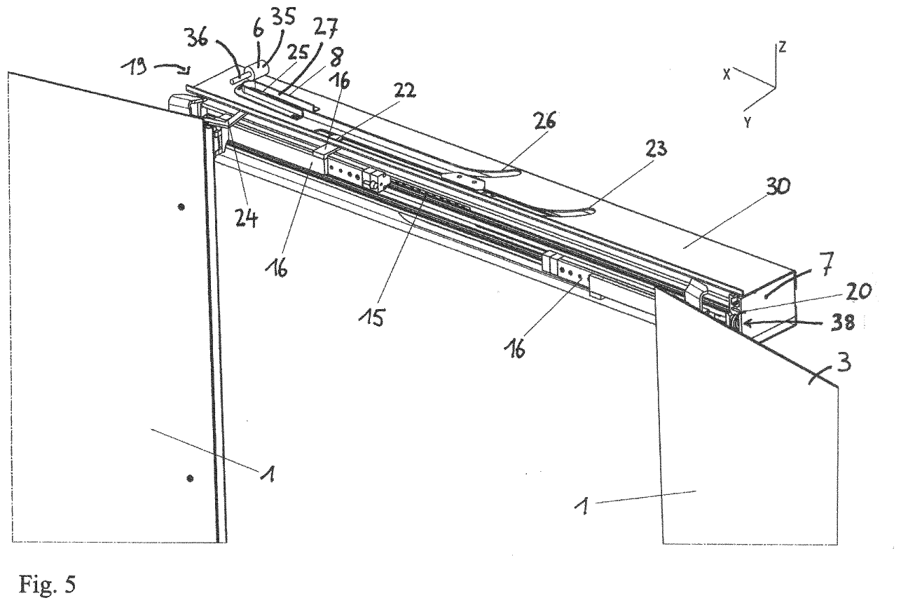

FIG. 5 shows fastening means 7 for fastening the swinging-sliding door 100 on the vehicle. The fastening means are designed stationary in relation to the not-shown vehicle. The fastening means may be threaded bores for receiving fastening screws.

The door leaf guide 10 comprises a translational guide 11 that has a carrier 15 with a longitudinal extent extending in the longitudinal direction X, wherein said carrier has a linear longitudinal guide 16, by means of which the door leaf 1 is mounted on the carrier 15 so as to be displaceable in the longitudinal direction X. The translational guide 11 additionally comprises a linear transverse guide 18, by means of which the carrier 15 is mounted so as to be displaceable relative to the fastening means 7 in the transverse direction Y.

The translational guide 11 preferably comprises a translational guide arm 21, which is connected to the linear longitudinal guide 16 and on which a translational guide roller 22 preferably is arranged. In addition, the translational guide 11 comprises a translational guide track 23, which is arranged stationary in relation to the fastening means 7 and in which the translational guide roller 22 is arranged.

The linear transverse guide 18 comprises two guide parts 19, 20 on the ends of the carrier 15. It may have a roller guide 38 (FIG. 5). The linear longitudinal guide may also comprise a roller guide.

The translational guide track 23 has straight sections extending parallel to the longitudinal direction X and curved sections.

The door leaf guide 10 also comprises a rotational guide 12. The rotational guide comprises a pivot joint 17, by means of which the door leaf 1 is connected to the linear longitudinal guide 16. The rotational guide 12 has a rotational guide arm 24 that is connected to the door leaf 1 and provided with a rotational guide roller 25, which rolls in a rotational guide track 26 that is arranged stationary in relation to the fastening means 7. The extent of the rotational guide track 26 can be changed by means of the controllable actuator 6 (see FIGS. 6 and 7).

The rotational guide track 26 preferably has a non-adjustable section 28 and an adjustment section 27. The translational guide track 23 and the rotational guide track are completely identical with the exception of the adjustment section 27, i.e. both tracks can be projected on one another. The adjustment section 27 is straight.

The adjustable guide element 8 is mounted so as to be rotatable about an adjustment axis 14. The adjustment axis 14 extends parallel to the joint axis 29. The adjustable guide element 8 may be U-shaped as illustrated, for example, in FIG. 5. The adjustment axis 14 may be arranged in one leg of this U-shape. The other leg may have a slot guide 39 with a curved slot that guides a rotation of this leg about the adjustment axis 14 (FIG. 4).

A certain motion travel of the door leaf 1 takes place depending on the shape and/or length and/or rotational position of the adjustable guide element 8, more precisely the adjustment section 27.

For example, a purely translatory motion travel (see, for example, FIGS. 1 to 3) takes place when the adjustment section 27 forms a straight extension of the non-adjustable section 28 and a motion travel comprising translatory and rotatory components (see, for example, FIGS. 1, 2 and 4) takes place when the adjustment section 27 is turned.

The translational guide track 23 and the rotational guide track 26 are produced in a guide plate 30. The adjustable guide element 8 is rotatably mounted on the guide plate 30.

A tensile force originating from the rotational guide roller 25 acts upon the door leaf 1 when the translational guide roller 22 and the rotational guide roller 25 roll in non-identical regions of the translational guide track 23 and the rotational guide track 26. The rotational guide arm 24 is designed in such a way that this tensile force is introduced into a rigid element permanently connected to the door leaf 1 on a region that does not lie on a line with the imaginary connection between the rotational guide roller 25 and the joint axis 29, but rather is spaced apart from this line by a distance 31. The tensile force is introduced into a lever section 32 of the rotational guide arm 24, which is designed perpendicular to the remaining rotational guide arm 24 (see, for example, FIG. 6). The distance 31 forms the effective lever arm for the rotation of the door leaf 1.

The guide tracks 23, 26 can also be referred to as guide slots.

The translational guide arm 21 produces a rigid connection between the pivot bearing of the translational guide roller 22 and the linear longitudinal guide 16 and the rotational guide arm 24 produces a rigid connection between the pivot bearing of the rotational guide roller 25 and the door leaf 1.

The door leaf displacement device 5 comprises just one door leaf drive 13 that is fastened on the carrier 15 stationary in relation thereto, wherein said door leaf drive has just one driving motor in the form of an electric rotary motor that causes a displacement of the linear longitudinal guide 16 relative to the carrier in the longitudinal direction X. In this case, the translational guide roller 22 moves along the translational guide track 23 such that a coordinated translatory motion of the door leaf 1 takes place in the longitudinal and the transverse direction. The power transmission between the door leaf drive and the linear longitudinal guide is realized, for example, by means of a belt 34 that is merely indicated in FIGS. 6 and 7.

The controllable actuator comprises a servomotor 35 in the form of an electric rotary motor. The power transmission between the controllable actuator and the adjustable guide element may be realized, for example, by means of a spindle drive 36.

The swinging-sliding door of the disclosed vehicle comprises a control 9 with a control input and a control output. A steering angle sensor 37 for detecting the steering angle of the vehicle is provided on the not-shown vehicle and the control input is operatively connected to the steering angle sensor 37. The angle value of the steering angle deflection therefore is transmitted to the control. The control output is operatively connected to the actuator 6.

FIG. 8 shows a closed position 2, an open position 3 and intermediate positions 4 of the door leaf 1 when the adjustable guide element 8 is positioned as illustrated in FIG. 3. FIG. 9 shows an open position 3 and intermediate positions 4 of the door leaf 1, which were changed by adjusting the adjustable guide element 8 into the position illustrated in FIG. 4.

1. A swinging-sliding door for a vehicle with fastening means for fastening the swinging-sliding door on the vehicle and
a door leaf configured to be displaced between a closed position and an open position via intermediate positions, and
with a door leaf displacement device for displacing the door leaf, wherein the door leaf displacement device has a controllable actuator, as well as a guide element configured to be adjusted by the controllable actuator, and in that the open position and/or the intermediate positions of the door leaf configured to be changed by adjusting the adjustable guide element.

2. The swinging-sliding door according to claim 1, wherein the dislocation of the door leaf between the closed position and the open position comprises a component of a translatory displacement of the door leaf, as well as a component of a rotatory motion of the door leaf about a rotational axis, and in that the rotatory motion is configured to be changed by adjusting the adjustable guide element using the controllable actuator.

3. The swinging-sliding door according to claim 1,
wherein the swinging-sliding door comprises a control with an input and an output, and in that the control is designed for receiving steering angle deflection signals of a wheel of the vehicle via the input and the output is operatively connected to the controllable actuator.

4. The swinging-sliding door according to claim 1, wherein the door leaf displacement device comprises a door leaf guide for guiding the door leaf between the closed position and the open position via intermediate positions, as well as a door leaf drive.

5. The swinging-sliding door according to claim 4, wherein the door leaf guide comprises a translational guide having a carrier with a longitudinal extent extending in the longitudinal direction (X), wherein said carrier has a linear longitudinal guide, through which the door leaf is mounted on the carrier so as to be displaceable in the longitudinal direction (X), in that the translational guide comprises a linear transverse guide, through which the carrier is mounted so as to be displaceable relative to the fastening means in the transverse direction (Y), in that the translational guide comprises a translational guide arm, which is connected to the linear longitudinal guide and on which a translational guide roller is arranged, and in that the translational guide comprises a translational guide track that is arranged stationary in relation to the fastening means, wherein the translational guide roller is arranged in the translational guide track.

6. The swinging-sliding door according to claim 4, wherein the door leaf guide comprises a rotational guide having a rotational guide arm, which is connected to the door leaf and on which a rotational guide roller is arranged, and in that the rotational guide comprises a rotational guide track that is arranged stationary in relation to the fastening means, wherein the rotational guide roller is arranged in the rotational guide track and the extent of the rotational guide track configured to be changed by the controllable actuator.

7. The swinging-sliding door according to claim 1, wherein the door leaf displacement device comprises just one door leaf drive.

8. The swinging-sliding door according to claim 1, wherein two door leaves are provided, wherein the dislocations of said door leaves between the closed position and the open position deviate from one another.

9. A vehicle with a swinging-sliding door according to claim 1, wherein the swinging-sliding door or the vehicle comprises a control with a control input and a control output and a steering angle sensor is provided for detecting the steering angle of the vehicle, and in that the control input is operatively connected to the steering angle sensor and the control output is operatively connected to the controllable actuator.

10. A method for operating a swinging-sliding door according to a vehicle according to claim 9, the method including the following steps: determining the steering angle of the vehicle, and changing the open position and/or the intermediate positions of the door leaf in dependence on the determined steering angle.
